(19) United States
(12) Patent Application Publication
(10) Pub. No.: US 2010/0332260 A1
(43) Pub. Date: Dec. 30, 2010

(54) PERSONAL RECORD SYSTEM WITH CENTRALIZED DATA STORAGE AND DISTRIBUTED RECORD GENERATION AND ACCESS

(76) Inventor: George I KASSAS, Salem, NH (US)

Correspondence Address: DAVIS & BUJOLD, P.L.L.C., 112 PLEASANT STREET, CONCORD, NH, 03301, US

(21) Appl. No.: 12/881,609

(22) Filed: Sep. 14, 2010

Related U.S. Application Data
(63) Continuation-in-part of application No. 12/499,914, filed on Jul. 9, 2009.
(60) Provisional application No. 61/111,490, filed on Nov. 5, 2008.

(51) Int. Cl. G06Q 50/00; G06K 5/00; G06K 19/00

(52) U.S. Cl. 705/3; 235/380; 235/487

(57) ABSTRACT

A personal record system and method having distributed record generation and access and personally centralized record storage for generating, storing and accessing personal records and a personal record card for use therein. The record system includes a plurality of interaction sites interconnected through a record network wherein each interaction site includes a record card read/write device, a record storage subsystem for storing at least records, and a record transaction process connected with the record card read/write device and record storage system for reading records from a record card and writing records to a record card and with the record network for transmitting records to and receiving records from at least other interaction sites.

### CROSS REFERENCES TO RELATED APPLICATIONS

The present Application relates to and claims benefit of U.S. Provisional Patent Application Ser. No. 61/111,490 filed Nov. 5, 2008 by George Kassas for a CENTRALIZED MEDICAL RECORD SYSTEM and U.S. patent application Ser. No. 12/499,914 filed Jul. 9, 2009 by George Kassas for a PERSONAL RECORD SYSTEM WITH CENTRALIZED DATA STORAGE AND DISTRIBUTED RECORD GENERATION AND ACCESS.

### FIELD OF THE INVENTION

The present invention relates to a system and method for the generation and storage of confidential personal records, such as medical and dental records, and, in particular, a record system and method having a primary record storage that is centralized with respect to the person to which the record pertains but distributed with respect to record generation and access.

### BACKGROUND OF THE INVENTION

A major factor in the effectiveness, quality, timeliness and costs of all forms of medical care, including, for example, dental care, is the maintenance of and access to accurate, complete and up to date medical records containing all medically related information relevant to the person to which a record pertains, such as the person's medical history and current condition, medications, test results and histories, x-ray photographs, treatment plans and relevant demographic and financial information, such as insurance coverage.

At present, however, the medical records pertinent to a given person typically comprise a mixture of hard copy documentation and computer database records scattered among various health care providers and businesses that presently, or in the past, have or have had medically related transactions with that person. Such records may include, for example, records residing in doctor's offices, hospitals and laboratories, medical services and facilities networks, emergency rooms, insurance company files and even possibly in the person's memory.

Because such records are created and updated independently of one another, the completeness of the records vary widely so that many of the records contain only a small part of a patient's history or often contain only a very specialized and narrow type of information. Sometimes the information stored in different records contains errors and is mutually contradictory. In addition, there is typically no effective and reliable linkage between the records or between the records and a patient to allow the reliable and efficient recovery of all records pertinent to a given person, or the transmission of the information in the records to a service facility or practitioner presently providing services to that patient. The current fragmentation of medical data and records between medical facilities and services and the lack of a fast, efficient and effective means to communicate medial data and records among medical facilities and services severely and potentially disastrously limits the rapid, reliable and effective correlation of medical and medically pertinent demographic and geographic data between or among medical facilities and services. This limitation, in turn, severely limits the ability of medical facilities and services, such as the Center for Disease Control, the Department of Health and Human Services and Homeland Security, to perform statistical and probabilistic analyses for the early detection of pandemic diseases, bio-hazards and potential terrorist chemical or biological attacks.

Even where some system or method exists for linking the records residing in different repositories, such as in medical facilities and services networks, such linkages typically cover only those residing within a single medical network. Even where there is some linkage between records and patients—such as within a medical network—access to and recovery of the information is often slow and unreliable. In many instances, the practitioner or facility is forced to turn to the patient's memory for information necessary to treat the patient, such as any medical conditions, medications and symptoms. The patient's memory relating to medical history, conditions, medications, etc., is many times unreliable and prone to error. This problem is compounded by the fact that the patient may not be in the best mental condition to recall such information. The need or tendency for a medical facility or practitioner to repeatedly ask questions regarding the patient's medical history, conditions, medications and symptoms, generally by each new practitioner seeing the patient, may result in corrected or more complete information or equally may possibly result in the introduction of further errors. This problem is particularly compounded by the possibility that the patient's mental facilities may not be at their best at that time.

There is therefore a significant risk with present systems and methods for recording and accessing medical records that a medical facility or practitioner may be unaware of the existence of information pertinent, or possibly critical, to a patient, such as a medical history or condition or a medication, may be unable to identify or locate significant medical records or to obtain the information from those records in time to serve a present purpose, and may even be unable to determine whether a patient has medical insurance coverage or the type of coverage.

The present invention provides a solution to the above noted as well as other related problems of the prior art.

### SUMMARY OF THE INVENTION

Wherefore, it is an object of the present invention to overcome the above mentioned shortcomings and drawbacks associated with the prior art.

The present invention is directed to a personal record system and method for generating, storing and accessing personal records and a personal record card for use therein wherein the record system is characterized by distributed record generation and access and personally centralized record storage.

According to the present invention, the record system includes a plurality of interaction sites interconnected through a record network wherein each interaction site includes a record card read/write device, a record storage subsystem for storing at least records, and a record transaction process connected with the record card read/write device and record storage system for reading records from a record card and writing records to a record card and with the record network for transmitting records to and receiving records from at least other interaction sites.

The system further includes one or more record cards for storing records wherein each record card is uniquely associated with a corresponding person and includes a plurality of records, such as personal information pertaining to the associated person, current personal information, personal history information, and at least one encoding key for encrypting and decrypting the records.

The record system may further include at least one data repository connected with the record network for storing copies of records stored on the record cards and/or at least one system management facility connected with the record network for managing operation of the record system, including uniquely associating a record card with a person, and the records stored on a record card may further include, for example, a source identification identifying a source of a corresponding record and/or a unique identifier of the record card and the associated person.

In further aspects and embodiments of the present invention, the record system may comprise a medical record system wherein the records are medical records of the associated person and wherein the current personal information includes current medical information, the personal history information includes medical history information, and the records may further include medical insurance information.

In a medical record system, the interaction site may include one or more of a doctor's office or a medical clinic, a specialized medical service facility, a mobile medical unit or an emergency medical unit, a hospital or a hospital department, a pharmacy, a private care facility, a home care unit, an insurance provider, and a governmental agency or a government service.

### BRIEF DESCRIPTION OF THE DRAWINGS

The invention will now be described, by way of example, with reference to the accompanying drawings in which:

FIG. 1 is a diagrammatic representation of a record system;

FIG. 1A is a diagrammatic representation of a record system showing a further modification thereof;

FIG. 2 is a diagrammatic representation of record data fields of a record card; and,

FIG. 3 is a flow diagram illustrating a process for generating and storing records in a record card.

### DETAILED DESCRIPTION OF THE INVENTION

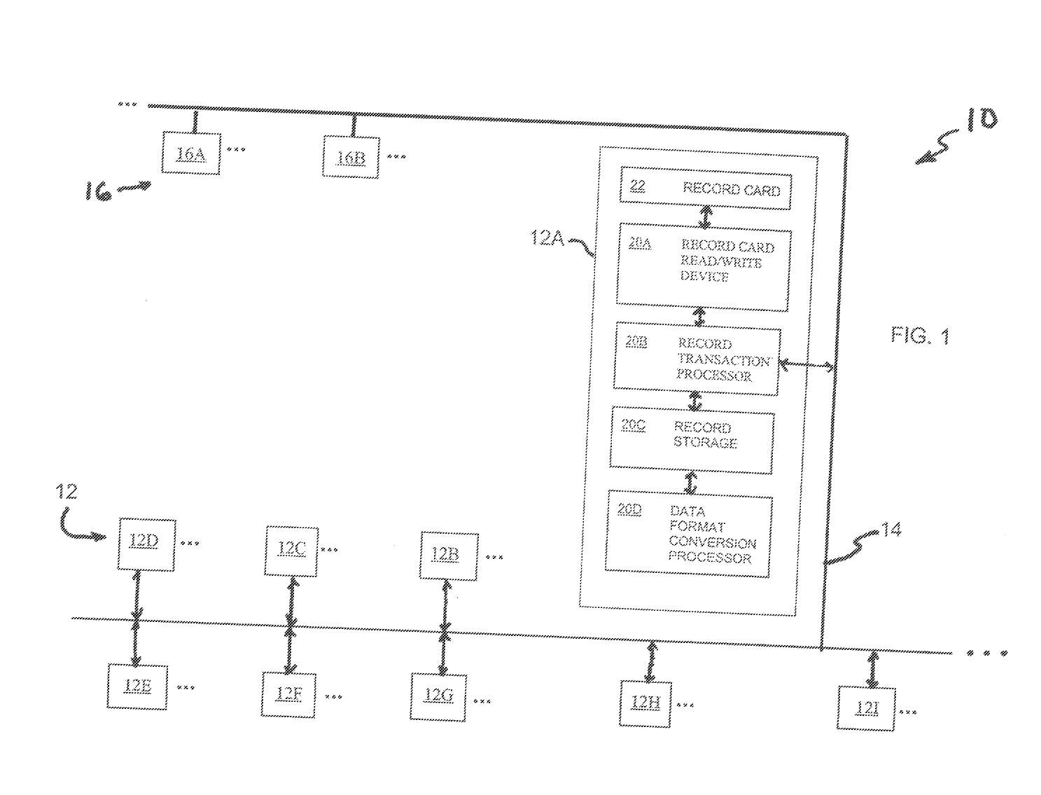

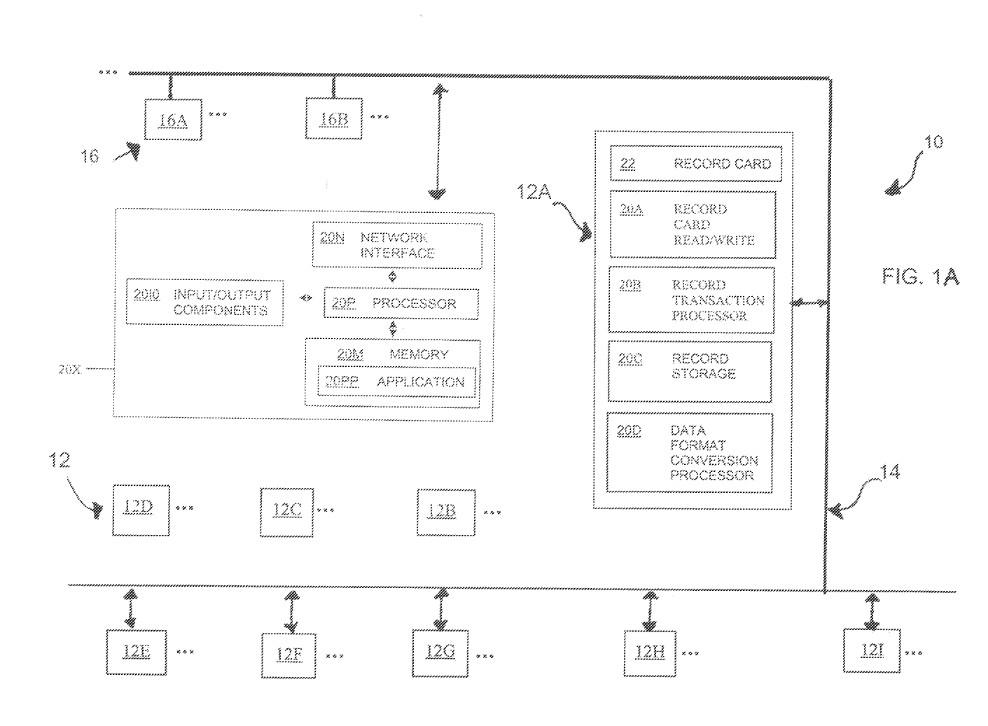

Referring to FIG. 1, therein is shown a diagrammatic representation of a record system 10 of the present invention and, while a record system 10 will be described in the following as implemented for a medical record system, it will be understood that the record system 10 may also be implemented, for example, for dental care or for any other form of data or information requiring wide distribution of or access to confidential information or records. It will thereby be understood that in the following description, the term “medical care” will include, for example, dental care, and that the record system 10 of the present invention is not limited solely to medical or dental care systems but may be similarly implemented for any type of record or information system providing wide distribution of or access to confidential information or records.

As illustrated in FIG. 1, and first considering the general elements and structures of the record system 10, the system typically includes a plurality of patient interaction sites 12 (e.g., 12A, 12B, 12C, 12D, 12E, 12F, 12G, 12H, 12I, . . . ) and a record network 14 and may typically include at least one system facility 16 that may include, for example, one or more data repository 16A and/or one or more system management facility 16B.

In the present exemplary embodiment of the record system 10 as represented in FIG. 1, patient interaction sites 12 (e.g., 12A, 12B, 12C, 12D, 12E, 12F, 12G, 12H, 12I, . . . ) may comprise all sites, facilities or persons or groups of persons providing medical services to a patient or dealing with information pertaining a patient. Patient interaction sites 12 (e.g., 12A, 12B, 12C, 12D, 12E, 12F, 12G, 12H, 12I, . . . ) may include, for example, a doctor's office or clinic 12A, a specialized service facility 12B such as various types of laboratories, X-ray and scanning facilities providing specialized or a limited range of services, a mobile and emergency unit 12C such as an ambulance, EMT (emergency technician) or a paramedic team, an emergency room or various other hospital departments 12D, a pharmacy 12E, a private care facilities 12F, a home care unit 12G, and any of a wide variety of other medical service and support facilities and agencies, including an insurance provider 12H, a governmental agency and service 12I, etc.

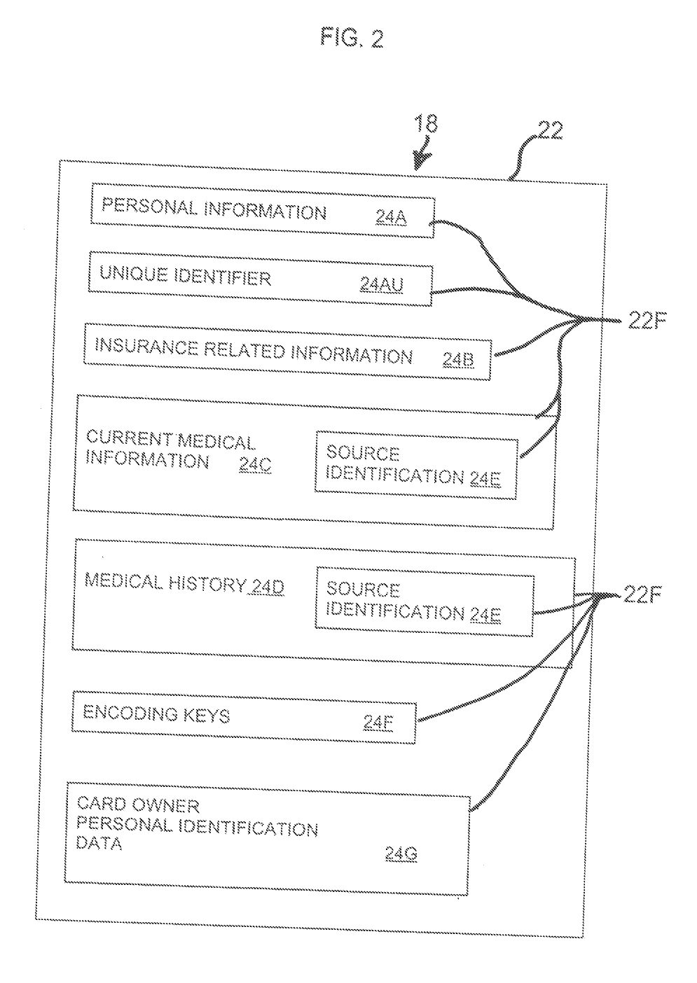

The record repository 16A, in turn, is a facility for the primary purpose of storing and providing records 18 (see FIG. 2) which, in the present exemplary embodiment, typically comprises records pertaining to patients and medical services. The system management facility 16B, in turn, is a facility for the primary purpose of providing system management and support functions to the record system 10, although certain system facilities 16 (16A, 16B, . . . ) may provide both sets of functions. Additionally, system management facility 16B can be a disaster recovery back up site for system management facility 16A

The record network 14, in turn, interconnects patient interaction sites 12 (e.g., 12A, 12B, 12C, 12D, 12E, 12F, 120, 12H, 12I, . . . ) and the system facility 16 (16A, 16B, . . . ), including one or more record repository 16A and/or system management facility 16B, for the purpose of accessing and communicating records 18 and providing communication services for the system management and the support functions. The record network 14 may include, for example, any form of wide area, local or “cloud” (e.g., managed and unmanaged) network, and may comprise various types of interconnected networks and may include, in part or in whole, the Internet. As discussed further in the following discussion, and in addition to providing sufficient carrying capacity and data transmission speed for the anticipated loads, the record network 14, the patient interaction sites 12 (e.g., 12A, 12B, 12C, 12D, 12E, 12F, 12G, 12H, 12I, . . . ) and the system facility 16 (16A, 16B, . . . ) should provide security for the records 18 that is proportionate to the value of the records 18 and to the effort that is likely to be invested in penetrating that security.

Referring to patient interaction sites 12 (e.g., 12A, 12B, 12C, 12D, 12E, 12F, 12G, 12H, 12I, . . . ) as represented in FIG. 1, each patient interaction site 12 (see specifically 12A) will typically include a record card read/write device 20A and a record transaction processor 20B that will typically be connected with record network 14 and that may be connected to yet other devices or networks 14. As will be discussed further in the following description, the record card read/write device 20A reads information from and writes information to the records 18 stored on a record card 22 that includes, for example, a magnetic storage medium, an optical storage medium or a “flash” memory device or a combination thereof. The record card 22 may also include a small battery, or some other suitable power supply, for such recording media, which requires power to main data stored therein or facilitate reading or writing of records from or to the recording media. Optical storage mediums and read/write devices 20A, for example, may be preferred because, at present, optical storage mediums typically provide greater storage capacity and comprise a relative permanent archival record of all information written thereupon. That is, many optical storage mediums typically can only be written onto, so that all erasures or modifications of the information stored on an optical medium are in the form of a writing of new data or an overwriting of previously written data and thereby leave a permanent record of any erasure or modification. It must be recognized, however, that record read/write devices 20A are not limited to optical devices but may include a device(s) employing any form or type of storage element suitable for the intended purposes as described herein.

The record transaction processor(s) 20B may range, for example, from a personal computer or dedicated record processor to a mainframe computer or centralized or distributed network of computers and processing units and, in part, manage and control the reading and writing of the information comprising the record 18 between a record card 22 and one or more record storage systems 20C located at or communicating with the patient interaction site 12 (e.g., 12A, 12B, 12C, 12D, 12E, 12F, 12G, 12H, 12I, . . . ). Typical the record storage system 20C includes, for example, an on site storage device such as a local hard drive, a non-volatile storage device or some other mass storage device or a mass storage device accessible through the record network 14, such as the record repository 16A, the system management facility 16B, another interaction site(s) 12A-12I, . . . , including another doctor's office(s), a hospital(s), a clinic(s), an emergency room(s), a doctor's office system(s), a specialized or dedicated medical device(s) or system(s), such as blood and biological fluid analyzers and various forms of imaging devices, such as scanning devices, including X-ray, CAT, and ultrasound systems, etc.

In the record system 10 according to the present invention, as described above, the system elements comprising patient interaction sites 12 (e.g., 12A, 12B, 12C, 12D, 12E, 12F, 12G, 12H, 12I, . . . ), including a record card read/write devices 20A and record transaction processor 20B, and the record network 14 with at least one system facility 16, including one or more of data repository 16A and/or at least one system management facility 16B, together comprise a distributed system for record generation and access. The second element of a record system 10 of the present invention, that is, a primary record storage that is centralized with respect to the person to which the record pertains, comprise record cards 22 wherein there is at least one record card 22 corresponding to and uniquely associated with each person represented in records 18.

According to the present invention, the record card 22 associated with and corresponding to a given person contains an essentially complete copy of all information pertinent to that person within the intents and purposes of the record system 10.

In the present exemplary medical record system 10, for example, and as illustrated in FIG. 2, the medical record card 22 may include, for example, a record field 22F containing basic personal information 24A, typically including the person's name, age, social security number, address and phone numbers, emergency contacts, and so forth. Other personal information would include, for example, a unique identifier 24AU uniquely identifying the person and/or the record card 22 and validating the record card 22.

Further record fields 22F would typically include, for example, insurance related information 24B, including the identifications of insurance coverage, types and personal identification for insurance purposes, and so on, current medical information 24C, such as current medical conditions, medications, warnings and alerts, and baseline medical information such as the most recent blood pressure and heart rate averages, most recent metabolic panel and blood profile, an exemplary EKG record, and so forth.

Record fields 22F will preferably further include medical history 24D fields, which will contain visit and test results and a record of each encounter with, for example, the person's primary care provider and/or clinics 12A, specialized service facilities 12B such as various types of laboratories, X-ray and scanning facilities providing specialized or a limited range of services, mobile and emergency units 12C such as ambulances, EMT (emergency technician) and paramedic teams, emergency rooms, various other hospital departments 12D, pharmacies 12E, private care facilities 12F, home care units 12G, and any of a wide variety of other medical service and support facilities and agencies, including insurance providers 12H and governmental agencies and services 12I, the medical history 24D will preferable include, for example, the date, time and reasons for each patient/provider encounter, any test results or other pertinent medical information resulting from each encounter, including EKGs, imaging results including, for example, X-ray, CAT and ultrasound images, and contact information, including the address on the record network 14 and/or the locations of the facilities generating and/or storing the original encounter data.

It must be noted that, as discussed above, records 18 may be written into the record fields 22F of a record card 22 by any of a variety of interactions sites 12 (e.g., 12A, 12B, 12C, 12D, 12E, 12F, 12G, 12H, 12I, . . . ) and, for this reason, each record 18 in a record card 22 will preferably include one or more source identification 24E fields containing information providing an audit trail and reliability indication for each record 18 written into the record card 22. Source identifications 24E may contain, for example, an identification, the address of the record network 14 and the authorization code of the interaction site 12 (e.g., 12A, 12B, 12C, 12D, 12E, 12F, 12G, 12H, 12I, . . . ) that was the source of the information in the record 18 and an identification, the record network 14 address and the authorization code of the interaction site 12 (e.g., 12A, 12B, 12C, 12D, 12E, 12F, 12G, 12H, 12I, . . . ) where the information was actually written into the record card 22. For these purposes, an authorization code may indicate, for example, the relative reliability, security level and confidence level of the interaction site 12 in question; for example, a system management facility 16B may have a higher authorization level that a local interaction site 12 and the local interaction site 12 may have a higher authorization level than a comparable but remote interaction site 12.

In many embodiments of a record system 10, and as discussed in further detail in a following discussion, the information stored in record fields 22F will preferably be encrypted for data security and privacy and, for these purposes, record fields 22F may further include one or more encoding keys 24F, with the number and type of the encoding keys 24F being determined by the encoding scheme employed and the desired level of security, as discussed below in further detail.

It must also be noted with respect to the storage of information in a record card 22 that the information contained in a record 18 or in a group of related records 18, such as the results of a series of medical imaging processes, may comprise a volume of data that is inconvenient to store on a record card 22. In such instances, and if it is necessary to store the record or records 18 on a record card 22, it may be necessary to either compress the data on the record 18 to select and store in the record card 22 only the diagnostically most significant records 18 or portions of the records 18, such as selected ones of multiple images resulting from one or more imaging processes. In yet other instances, the information contained in one or more records 18 may be of a nature, such as highly confidential information, that it is undesirable for the information to be stored on a record card 22, even given the levels of security provided on a record card 22. In such instances, wherein it is impractical or undesirable to store the record or the records 18 on a record card 22 but wherein it is necessary or desirable for the information in the records 18 to be accessible, if required, an identification of and an address of the network 14 of the record or records 18, and perhaps the authorization code or codes of the site or sites 12 (e.g., 12A, 12B, 12C, 12D, 12E, 12F, 12G, 12H, 12I, . . . ) originating the record 18 and at which the record 18 is stored, may be stored on the record card 22 in place of the actual record or records 18. The identification of and address of the network 14 of the record or records 18 and the authorization code or codes may then be used by the patient interaction site 12 (e.g., 12A, 12B, 12C, 12D, 12E, 12F, 12G, 12H, 12I, . . . ) to read the record or records 18 from the site 12 at which the record or records 18 are stored. As stated, however, an essential concept of the present invention is that a record card 22 should be the primary record storage for all records 18 pertaining to the corresponding person, so such instances of remote storage, rather than on-card storage, should preferably be used only where necessary, and in cases where records need to be backed up to a centralized database facility.

It addition, it is preferable that a record system 10 employ a common data format or set of formats for all records 18, regardless of where or how the records 18 are generated or stored in the record system 10. It is recognized, however, that presently existing medical systems utilize a variety of data formats for record storage. The implementation of a record system 10 from existing facilities and systems will thereby require data format translations when passing records 18 or information therefrom among patient interaction sites 12 (e.g., 12A, 12B, 12C, 12D, 12E, 12F, 12G, 12H, 12I, . . . ) and the system facility 16, including one or both of a record repository 16A and/or system management facility 16B. Accordingly, and for this purpose, the patient interaction sites 12 (e.g., 12A, 12B, 12C, 12D, 12E, 12F, 12G, 12H, 12I, . . . ) and the system facilities 16, including one or both of the record repository 16A and/or the system management facility 16B, will typically include data format conversion processors 20D. Such data format translation facilities and methods are, however, well known and commonly employed in the relevant arts. It should also be noted that the implementation and use of the record systems 10 will, over time, encourage the adoption of a common data format or set of formats.

Next considering the methods by which records 18 are created, stored and accessed in a record system 10, it has been described above that a record system 10 of the present invention provides a primary record storage that is centralized with respect to the person to which the record pertains but distributed with respect to record generation and access. The centralization of record generation, storage and access is provided by record cards 22, which comprise the primary record storage facility associated with each person. As described above and as discussed below, each record card 22 is possessed by and uniquely associated with a given person and is the primary storage mechanism for all records 18 generated by interactions between a person and a patient interaction site(s) 12 (e.g., 12A, 12B, 12C, 12D, 12E, 12F, 12G, 12H, 12I, . . . ).

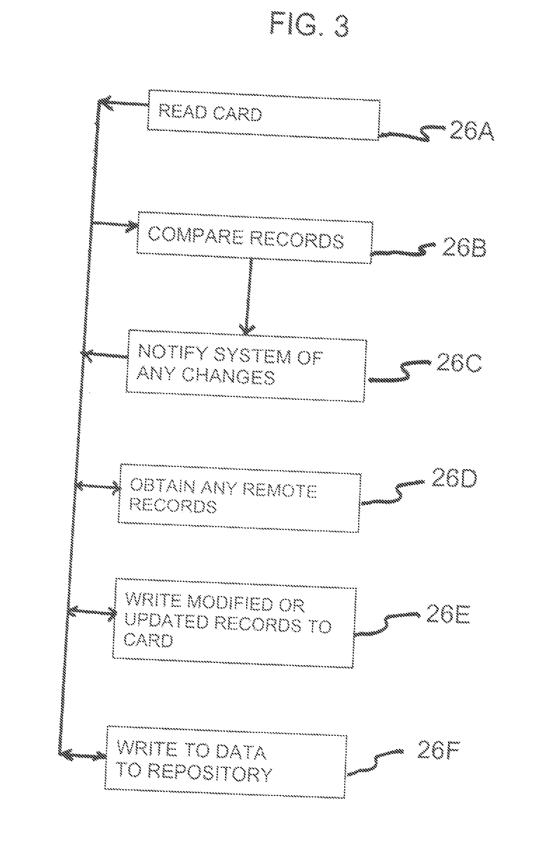

With reference to FIG. 3, an illustrative example of the process is shown for generating and storing records 18 in a record card 22, including accessing the records 18 of and writing the records 18 to remote patient interaction site(s)12 (e.g., 12A, 12B, 12C, 12D, 12E, 12F, 12G, 12H, 12I, . . . ) and/or the record repository 16A, for example.

As illustrated therein, when a person possessing a record card 22 enters a patient interaction site 12 (e.g., 12A, 12B, 12C, 12D, 12E, 12F, 12G, 12H, 12I, . . . ), at step 26A, the record card 22 is scanned and at least selected record fields 22F are read to an associated record transaction processor 20B by a record card read/write device 20A. The record fields 22F read to the record transaction processor 20B would typically include at least personal information 24A and would further include any other of record fields 22F appropriate to the patient interaction site 12 and the services or processes to be provided or performed. A visit to a doctor's office or a clinic 12A, for example, would typically also require the reading of any insurance related information 24B, current medical information 24C and medical history 24D while a visit to a pharmacy 12E, or a specialized service facility, may require only personal information 24A, any insurance related information 24B and current medical information 24C, which would include current prescriptions and current orders for specialized medical services, such as various types of laboratory analyses and scans.

Assuming, for purposes of an illustrative example only, that the patient interaction site 12 (e.g., 12A, 12B, 12C, 12D, 12E, 12F, 12G, 12H, 12I, . . . ) is the patient's primary interaction site 12A, such as the patient's primary care physician's office and that the interaction between the person/patient and the interaction site 12A is, for example, a review of the person/patient's current medical condition and medical history, possibly including a “follow-up” of a current medical issue, the personal information 24A, unique identifier 24AU, any insurance related information 24B, current medical information 24C and medical history 24D will be read from the person/patient's record card 22 by record card read/write device 20A and transferred into the record transaction processor 20B of the interaction site 12 (e.g., 12A, 12B, 12C, 12D, 12E, 12F, 12G, 12H, 12I, . . . ), in step 26A. At most interaction sites 12 (e.g., 12A, 12B, 12C, 12D, 12E, 12F, 12G, 12H, 12I, . . . ), the record transaction processor 20B will typically include the office system computer network, which will, in turn, be connected to or a part of the office or clinic medical records database, examination rooms, laboratories, and so on, so that the information from the record card 22 will be available to all of the service providers, such as doctors, nurses, lab technicians, administrative personnel, and so forth.

Assuming that the interaction site 12A is a primary interaction site for the person in question, such as the person's primary care provider, much of the information from the record card 22 will typically be available in the record transaction processor 20B of the interaction site 12A, and the next step in the process typically comprises, at step 26B, a comparison of the local records at the service provider's facility, with those stored on the record card 22. The information comparison thereby reveals new or altered information(s) in any of the record fields 22F, such as information entered at or from a different interaction site 12 (e.g., 12A, 12B, 12C, 12D, 12E, 12F, 12G, 12H, 12I, . . . ), such as a different doctor's office or clinic 12A, a laboratory or other specialist service facility 12B, a mobile or emergency unit 12C, a hospital department 12D, a pharmacy 12E, an insurance provider(s) 12H or governmental agencies and services 12I, and so forth. The medical service provider may thereby be alerted to any changes or events in the patient's medical condition or history and, at step 26C, the local copy of records 18 may be updated to represent the current state and history of the patient.

As discussed above, record fields 22F may contain records 18 entered into the record card 22 by another interaction site 12 (e.g., 12A, 12B, 12C, 12D, 12E, 12F, 12G, 12H, 12I, . . . ), such as a laboratory, clinic, emergency room, and so forth, by the process illustrated in FIG. 3, but as executed at that other interaction site(s)12 (e.g., 12A, 12B, 12C, 12D, 12E, 12F, 12G, 12H, 12I, . . . ). These remotely originated records 18 will be read from the record card 22 and to the record transaction processor 20B, in step 26A, together with the associated identification, the address of the network 14 and the authorization code of the originating interaction sites 12 (e.g., 12A, 12B, 12C, 12D, 12E, 12F, 12G, 12H, 12I, . . . ). As also discussed above, these remotely originated records 18 may comprise uncompressed data or compressed data, such as compressed images or records, or selected records or images comprising only the diagnostically most significant information generated by or at that interaction site 12, and should typically provide sufficient information on the subject matter of the records 18. It may be necessary or preferable upon occasion, however, to obtain the full copy of a compressed or summarized remotely originated record 18. In such cases, the full copy of the remotely originated record 18 may be obtained from the remote interaction site 12 (e.g., 12A, 12B, 12C, 12D, 12E, 12F, 12G, 12H, 12I, . . . ), at step 26D, by means of the source identifications 24E associated with the remotely originated record 18, such as the identification code and the address of the record network 14 of the remotely originated record 18.

Upon completion of a patient interaction with the current interaction site 12 (e.g., 12A, 12B, 12C, 12D, 12E, 12F, 12G, 12H, 12I, . . . ), all new, updated and modified records 18, generated in the course of the patient interaction with the interaction site 12 (e.g., 12A, 12B, 12C, 12D, 12E, 12F, 12G, 12H, 12I, . . . ), will be written, at step 26E, from the record transaction processor 20B and into the record card 22 by the record card read/write device 20A. As discussed above, complete copies of all newly generated, updated and modified records 18, generated during the patient interaction, will preferably be stored in the record card 22, with the exception of certain records 18 that, for a variety of reasons, are stored therein in compressed or summarized form or, in rare instances, in the form of an identification and record web address of the pertinent remotely stored record 18.

At this time, that is, when the new, updated or modified records 18 are written to the record card 22, the new, updated or modified records 18 and any related message(s) may also be transmitted to other sites 12 (e.g., 12A, 12B, 12C, 12D, 12E, 12F, 12G, 12H, 12I, . . . ), such as an insurance company 12H, a pharmacy 12E or another patient interaction site 12 that is to perform or provide, for example, specialized medical services such as CAT scans, X-rays, various forms of analysis or treatment, such as physical therapy, and so forth. The new, updated or modified records 18 may also be written to and into one or more data repositories 16A, at step 26F, which are generally shared by all patient interactions sites 12 (e.g., 12A, 12B, 12C, 12D, 12E, 12F, 12G, 12H, 12I, . . . ) and the record cards 22 supported by the record system 10. Such data repository 16A thereby, by cumulative recording over time of all records 18 generated, updated or modified for all record cards 22 supported by the record system 10, comprise a comprehensive backup and archival storage for all records 18 stored in the record cards 22. It will be appreciated that the archived copies of records 18 stored in one or more data repositories 16A facilitate the recovery and/or reconstruction of the records 18 stored on a record card 22 upon the loss or destruction of the record card 22 and provide means by which the records 18, on a record card 22, may be validated or invalidated if any question should be raised regarding the completeness or accuracy of the records 18 on a record card 22.

It should also be noted, however, that the storage of copies of all newly created, modified or updated records 18 in the record storage system 20C of the interaction sites 12 (e.g., 12A, 12B, 12C, 12D, 12E, 12F, 12G, 12H, 12I, . . . ) creating, modifying or updating the records 18 provides an alternate method for recovery, reconstruction or validation of the records 18 of a given record card 22. That is, the interaction sites 12 (e.g., 12A, 12B, 12C, 12D, 12E, 12F, 12G, 12H, 12I, . . . ), the data repository 16A and record storage system 20C of the record system 10 may be queried through the record network 14 using the unique identifier 24AU identifying the person and/or corresponding record card 22 to locate and access the locally archived copies of records 18 of that record card 22. Copies of the locally archived records 18 may then be transmitted, through the record network 14, to the querying interaction site 12 (e.g., 12A, 12B, 12C, 12D, 12E, 12F, 12G, 12H, 12I, . . . ) or a system management facility 16B and reconstructed, as necessary and desired.

Finally briefly considering the system management facility 16B, the general functions performed by the system management facility 16B is providing system management and support functions for the record system 10, including all interaction sites 12 (e.g., 12A, 12B, 12C, 12D, 12E, 12F, 12G, 12H, 12I, . . . ), all data repositories 16A, all record cards 22, and so forth. The system management facility 16B will, for example, manage the operation of record network 14, install, validate, authorize and generate network addresses for interaction sites 12 (e.g., 12A, 12B, 12C, 12D, 12E, 12F, 12G, 12H, 12I, . . . ) and data repositories 16A, authorize and validate record cards 22 and the assignment of record cards 22 to individuals, and manage, distribute and validate encoding keys 24F for all record cards 22, interaction sites 12 (e.g., 12A, 12B, 12C, 12D, 12E, 12F, 12G, 12H, 12I, . . . ), data repositories 16A and system management facilities 16B, and so forth. As such functions are well known in the relevant arts, a further detail discussion concerning the same is not provided herein. Additionally, system management facility 16B can be a backup system management facility to system management facility 16A. Both system management facilities 16A and 16B can be deployed at the same site or be geographically separated but remain connected and synchronized to provide full backup status and enable a self-healing mechanism in the case of a disaster recovery.

Lastly considering security and privacy issues of a record system 10, it is apparent that the record system 10 preferably incorporates a security mechanism to provide a level of privacy and security that is sufficient and appropriate for the information residing therein. In this regard, it has long been well known that essentially any security system, which will typically take the form of an encryption mechanism in systems for the storage and transmission of information, may be penetrated if sufficient time and resources are devoted to defeating the system. For this reason, it has long been an established principle that the level of protection provided by an encryption method or other security mechanism, such as authorization codes and pin numbers, and thus the complexity and cost of the system, must be proportionate to the value and useful lifespan of the information to both the owners of the information and those parties desiring to obtain unauthorized access to the information. In general, it is accepted that the level of protection afforded by an encryption system is sufficient if the cost to penetrate the system exceeds the value of the information to the party attempting to penetrate the system or if, given the probable time required to penetrate the system, the information would no longer be of value.

It is also recognized that because of differences in the complexity and cost of the protection systems that may be maintained at the different elements of a record system 10, and because of differences in the volume of information stored at the different elements of a record system 10 and the number of persons effected by a security breach, a record system 10 may, in fact, incorporate multiple security and/or encryption systems, each designed to protect a certain aspect or set of aspects of the record system 10. For example, one encryption system may be used to protect the records 18 stored on record cards 22, another to protect the records 18 stored in the data repository 16A, the system management facility 16B and the record storage system 20C of the interaction site(s) 12 (e.g., 12A, 12B, 12C, 12D, 12E, 12F, 12G, 12H, 12I, . . . ), and a third to protect records 18 during transmission through record network 14.

The data repository 16A, the system management facility 16B and the record storage systems 20C of the interaction site(s) 12 (e.g., 12A, 12B, 12C, 12D, 12E, 12F, 12G, 12H, 12I, . . . ) all generally have sufficient memory capacity and processing power to employ many of the presently known and commonly used systems and methods for the protection of such system facilities 16 and need not be discussed further herein. In a like manner, the systems and methods for the protection of information in transit through networks, such as the record network 14, are also well known and widely used, such as the data transmission encryption methods and protocol already incorporated into the Internet, and also need not be discussed further herein.

Protection of the record cards 22 themselves and the information stored therein, however, is more difficult. That is, and for example, although it is preferable that at least the essential components of the record card 22 security mechanism be contained within the record card 22 and while the record card 22 has significant memory capacity, it is likely to have no or very limited internal processing capacity. This, however, is in accordance with current security mechanisms wherein security is provided by encoding keys rather than by the mechanism using the encoding keys to encrypt or decrypt the information to be protected. In the case of record cards 22, therefore, the processing power to encrypt or decrypt the information stored or to be stored on a record card 22 may readily be provided by the interaction site 12 (e.g., 12A, 12B, 12C, 12D, 12E, 12F, 12G, 12H, 12I, . . . ) while each record card 22 itself stores the encryption and decryption keys to be used in the encryption/decryption processes for that record card 22.

It must also be noted that the level of security provided by the record card 22 security mechanisms is alleviated, to a certain degree, by the principle that the security to be provided need only be proportionate to the value of the records 18 to be protected and to the effort that is likely to be invested in penetrating that security. A party seeking to access protected information pertaining to individuals typically does so for financial gain and accordingly typically seeks to penetrate the security of records wherein each record is of potentially high value in itself, such as credit card numbers, or wherein the records are of lesser or little individual value but high aggregate value, such as social security numbers, drivers license records, and so forth. In the case of record cards 22, however, the information contained on any given record card 22 is not likely to be of significant value in itself, unless, for example, the person's credit card numbers are stored therein. It is also anticipated that each individual record card 22 will be, at all times, in the possession of the person with which it is associated and because a record card 22 can be accessed only by an interaction site 12 (e.g., 12A, 12B, 12C, 12D, 12E, 12F, 12G, 12H, 12I, . . . ) or an equivalent thereto, the opportunities for unauthorized accesses to record cards 22 would be relatively rare, would typically occur only one card at a time, an would require either theft of a record card 22 or penetration of an interaction site 12 (e.g., 12A, 12B, 12C, 12D, 12E, 12F, 12G, 12H, 12I, . . . ). In this regard, it must also be noted that a card security or encryption method that requires that the record card 22 be accessed only by an interaction site 12 (e.g., 12A, 12B, 12C, 12D, 12E, 12F, 12G, 12H, 12I, . . . ) or an equivalent thereto, that is, a record transaction processor 20B, or an equivalent, together with the necessary encryption/decryption algorithms and processes, not only reduces the number of third parties that could possibly access the records 18 therein, but effectively reduces the possibility that the owner of a record card 22 could access or alter their own records 18 for any reason.

In summary, therefore, and while there is a definite need to protect the information stored in the record cards 22, the need is essentially to provide privacy for the medical or other records 18 thereon and a sufficient level of security may be provided in the medical records application by a moderate level of security. Other applications, however, may require a higher level of protection.

There are a significant number of various types of security mechanism that would meet the security needs of a medical record system 10 and record cards 22 as well as the record storage systems 20C of the patient interaction sites 12 (e.g., 12A, 12B, 12C, 12D, 12E, 12F, 12G, 12H, 12I, . . . ) and the data repository 16A of the system facility 16 may be protected by combinations or layers of such security mechanisms. For example, any of the record cards 22, the record storage system 20C and the data repository 16A may employ a “public key” encryption system wherein the level of protection, which is primarily a function of the length of the encryption or decryption key, is dependent upon the security needs of the record card 22, the record storage system 20C or the data repository 16A. As is well known, in “public key” encryption systems, information is encrypted by one key, typically the “public” key, and decrypted by a second key, often referred to as the “private” key, or the reverse. In this instance, and in accordance with well known “public key” systems, public keys for the individual record cards 22 may be generated and distributed from any of a number of sites, such as a system management facility 16B or from a governmental agency 12I, or even generated as needed at interaction sites 12 given appropriate control of key generation and distribution from a central authority and coordination agency. The corresponding private key for a given record card 22 may then be generated from the public key assigned to that record card 22, and is a function that can be performed at, for example, any interaction site 12 (e.g., 12A, 12B, 12C, 12D, 12E, 12F, 12G, 12H, 12I, . . . ), with the public key and corresponding private key then being stored onto the newly issued record card 22, so that encoding keys 24F comprise the public and private keys assigned to that record card 22. Thereafter, any interaction site 12 (e.g., 12A, 12B, 12C, 12D, 12E, 12F, 12G, 12H, 12I, . . . ) may read the private key from the record card 22 when the record card 22 is interfaced with a suitable read/write device 20A and may use that private key to read the records 18 from the record card 22. The interaction site 12 (e.g., 12A, 12B, 12C, 12D, 12E, 12F, 12G, 12H, 12I, . . . ) may subsequently use the public key, read from the record card 22, to write copies of new, modified and/or updated records 18 into the record card 22. Lastly, it will be noted that essentially the same public/private key mechanism may be used in a digital “signature” mechanism for the record system 10 to allow the authentication of, for example, remotely generated or transmitted records 18.

It will be understood that protection for record cards 22 may be provided by the combination of a “public key” system with other security mechanisms to both control access to the record card 22 and to verify the validity of the record card 22, the owner of the record card 22 and the records 18 residing on the record card 22 during each access of the record card 22 by, for example, a patient interaction site 12 (e.g., 12A, 12B, 12C, 12D, 12E, 12F, 12G, 12H, 12I, . . . ).

For example, both a record card 22 and person presenting a record card 22 may be validated by requiring the person to provide a memorized personal identification number, often referred to as a PIN, or other form of password to be provided or entered by the record card 22 owner at the time the record card 22 is to be accessed, as is now commonly used for, for example, debit cards and automatic teller machines. In further example, both a record card 22 and person presenting a record card 22 may be validated by storing a copy of some personal, physical characteristics (i.e., personal identification data 24G) unique to the record card 22 owner, such as one or more of the owner's fingerprints, a DNA record, a photograph or other personal and physical identification data on the record card 22. The personal identification data 24G stored on the record card 22 may then be compared with corresponding personal identification information provided from the alleged record card 22 owner at the time of the intended record card 22 access.

In addition, the record cards 22 and record card read/write devices 20A may be designed so that no previously existing record 18, on a record card 22, will be or can be erased, but can only be marked as invalidated, so that a record card 22 contains a complete record of all record transactions involving that record card 22, thereby providing an audit trail that may assist in detecting unauthorized modifications of the records 18 of the record card 22. In this regard, and as described above, certain storage mediums, such as optical storage mediums, typically can only be written thereon, so that all erasures or modifications to the information stored on an optical medium are in the form of a writing of new data or an overwriting of previously written data and thereby leave a permanent record of any and all alterations and/or modifications thereto.

Lastly with regard to record security measures, any records 18 stored on a record card 22 that correspond to the records 18 generated by, stored at or accessible to the patient interaction site 12 (e.g., 12A, 12B, 12C, 12D, 12E, 12F, 12G, 12H, 12I, . . . ), where the record card 22 is to be accessed, may be compared with the corresponding records 18 stored at or accessible to the patient interaction site 12 (e.g., 12A, 12B, 12C, 12D, 12E, 12F, 12G, 12H, 12I, . . . ). A match between the records 18 stored at or accessible to the patient interaction site 12 (e.g., 12A, 12B, 12C, 12D, 12E, 12F, 12G, 12H, 12I, . . . ) and the records 18 in the record card 22 would thereby validate the records 18 on the record card 22 as being true copies of the records 18 stored at or accessible to the patient interaction site 12 (e.g., 12A, 12B, 12C, 12D, 12E, 12F, 12G, 12H, 12I, . . . ), or invalidate the records 18 on the record card 22 and possibly the alleged owner of the record card 22 if the records 18 do not match.

Lastly, considering further and alternate implementations of patient interaction sites 12, many of the patient interaction sites 12 discussed above were described in terms of devices that are or have been adapted or dedicated, to a certain degree, to the specific purposes and functions of a record system 10 by the inclusion of specific purpose components, such as a record card read/write device 20A. The present invention, however, recognizes and incorporates the need for and advantages of the capability to access records 18 from more general purpose devices that are not, in themselves, specifically or inherently dedicated to or specifically adapted to the purposes of a record system 10, such as “smart phones”, such as the Apple™ iPhone™, desktop or laptop personal computers, netbooks and virtually any other electronic communication device (all of such devices are collectively referred to therein as “general purpose devices”) as well as the application software incorporated therein which allows a user to practice the disclosed invention. Implementations of patient interaction sites 12, via such general purpose devices, are advantageous, for example, when a patient's record card 22 is not readily available when the need to access the patient's records 18 arises, such as when the patient has lost or misplaced the record card 22 or the patient is not carrying the record card 22 or is not located at a patient interaction site 12 such as a medical office, an EMT or a paramedic unit, or a hospital. As implementation of a patient interaction site 12, via a general purpose device belong to or under the control of the patient, allows the patient to gain access to the patient's records 18 to, for example, a doctor, an EMT or a paramedic or other party having reason to view the patient's records 18, while allowing the patient to retain control of the access to the patient's records 18.

Referring now to FIG. 1A, an exemplary implementation of a general purpose device such as a personal computer, netbook or smart phone is illustrated therein. As this embodiment is very similar to the embodiment of FIG. 1, the same elements are given the same reference numerals but are not discussed in detail. The general purpose device, as a patient interaction site 12X, is illustrated therein and typically includes a processor 20P, memory devices 20M for storing programs and data, such as disk drives and solid state memory, input/output components 20 IO, such as a display screen and keyboard or touchscreen, and a network interface 20N, such as an Internet or wireless connection. In such implementations the functional elements processes of a record system 10, including encryption and data conversion processes and the record 18 retrieval and display functions, will be implemented as an application program 2OPP, which is often referred to in the “smart phone” context as an “app”, i.e., and “application.”

It will be recognized that in such implementations of a patient interaction site 12 of a record system 10 as a patient interaction site 12X via a general purpose device, such as a personal computer or smartphone, the patient interaction site 12X will most typically not include a record card read/write device 20A, and so cannot read records 18 from or write records 18 to a record card 22. In addition, and for security and privacy reasons as well as for practical reasons, such as limited storage space on, for example, a smartphone, it is possible or probable that records 18 may not be stored in the general purpose device for an extended period of time, but would typically only be stored therein for temporary display purposes.

A patient interaction site 12X implemented via a patient's general purpose device will, of course, not have access to the records 18 on the patient's record card 22, but may access and display the copy of the patient's records 18 residing in, for example, a system facility 16, such as a data repository 16A or system management facility 16B. For this purpose, however, and for the security and privacy purposes discussed above, a patient interaction site 12X must store the unique identifier 24AU and encoding keys 24F corresponding to the patient and record card 22, in order to control and facilitate access to the patient's records 18 in the system facility 16. In addition, a patient interaction site 12X device may also store at least part of the personal information 24A pertaining to the patient and record card 22; this personal information may, for example, be transmitted to the system facility 16 for record purposes and to provide an additional security check by allowing the system facility 16 to confirm the unique identifier 24AU against the patient's personal information.

Also in this regard, it will be understood that the capabilities of using a general purpose device as a patient interaction site 12X to access and modify the records 18 stored at a system facility 16 will be determined and limited by the record 18 read and write capabilities of the personal record system application, or “app”, stored in the general purpose device being used as the patient interaction site device 12X. Therefore, and while the general purpose device being used as the patient interaction site device 12X must have record read and display capabilities, it may be desirable for security and data privacy purposes that the “app” or program of the general purpose device, being used as the patient interaction site device 12X, not include record write capabilities. A general purpose device, being used as the patient interaction site device 12X, that is limited in this manner thereby cannot modify the records 18 of a patient stored at a system facility 16, thus thereby further insure that a patient's records 18 can be modified only by appropriate authorized person(s) or facilities.

In conclusion, therefore, it will be seen that the general purpose device, being used as the patient interaction site device 12X, is essentially a patient interaction site 12 as described herein above, but in which the functions and elements of a patient interaction site 12 with a record card read/write device 20A and at least essential aspects of a record card 22 have been integrated into a single device also having a range of more general purposes and functions.

Since certain changes may be made in the above described record system and related method of implementing the same, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A personal record system having distributed record generation and access and personally centralized record storage, the personal record system comprising:
a plurality of interaction sites interconnected through a record network,
each interaction site including:
a record card read/write device,
a record storage subsystem for storing at least records, and
a record transaction process connected with the record card read/write device and record storage system for reading records from a record card and writing records to a record card and with the record network for transmitting records to and receiving records from at least one other interaction site, and
a plurality of record cards for storing records, each record card being uniquely associated with a corresponding person and including:
a plurality of records including:
personal information pertaining to the associated person,
current personal information,
personal history information, and
at least one encoding key for encrypting and decrypting the records.

2. The personal record system of claim 1, wherein at least certain records further include:
a source identification identifying a source of a corresponding record.

3. The personal record system of claim 1, wherein at least certain records further include:
a unique identifier of the record card and associated person.

4. The personal record system of claim 1, wherein:
the records are medical records of the associated person, and
the current personal information includes current medical information, and
the personal history information includes medical history information.

5. The personal record system of claim 4, wherein:
the records further include medical insurance information.

6. The personal record system of claim 1, further comprising:
at least one data repository connected with the record network for storing copies of records stored on the record cards.

7. The personal record system of claim 1, further comprising:
at least one system management facility, connected with the record network, for managing operation of the record system, including uniquely associating a record card with a person.

8. The personal record system of claim 1, wherein interaction sites comprise at least one of:
a doctor's office,
a medical clinic,
a specialized medical service facility,
a mobile medical unit,
an emergency medical unit,
a hospital,
a hospital department,
a pharmacy,
a private care facility,
a home care unit,
an insurance provider,
a governmental agency, and
a government service.

9. The personal record card system of claim 1, wherein a patient interaction site comprises a general purpose device including a processor, a memory for storing a record access and display program, a unique identifier of a corresponding patient, and at least one encoding key for decrypting the records, and a display and input/output element and a network connection.

10. A record card for storing records in a personal record system having distributed record generation and access and personally centralized record storage, the personal record system including a plurality of interaction sites interconnected through a record network, each interaction site including a record card read/write device, a record storage subsystem for storing at least records, and a record transaction process connected with the record card read/write device and record storage system for reading records from a record card and writing records to a record card and with the record network for transmitting records to and receiving records from at least other interaction sites, each record card being uniquely associated with a corresponding person and comprising:
a record card including a readable and writeable information storage media, and
a plurality of records including:
personal information pertaining to the associated person,
current personal information,
personal history information, and
at least one encoding key for encrypting and decrypting the records.

11. The record card of claim 10, wherein:
the records are medical records of the associated person, and
the current personal information includes current medical information, and
the personal history information includes medical history information.

12. The record card of claim 11, wherein:
the records further include medical insurance information.

13. The record card of claim 11, wherein interaction sites comprise at least one of:
a doctor's office,
a medical clinic,
a specialized medical service facility,
a mobile medical unit,
an emergency medical unit,
a hospital,
a hospital department,
a pharmacy,
a private care facility,
a home care unit,
an insurance provider,
a governmental agency, and
a government service.

14. The record card of claim 10, wherein a patient interaction site comprises a general purpose device including a processor, a memory for storing a record access and display program, a unique identifier of a corresponding patient, and at least one encoding key for decrypting the records, and a display and input/output element and a network connection.

15. A method for personally centralized record storage with distributed record generation and access and record storage in a record system including a plurality of interaction sites interconnected through a record network, each interaction site including a record card read/write device, a record storage subsystem for storing at least records, and a record transaction process connected with the record card read/write device and record storage system for reading records from a record card and writing records to a record card and with the record network for transmitting records to and receiving records from at least other interaction sites, comprising the steps of:
assigning a record card to each person having at least one record to be stored, each record card including a readable and writeable record storage media for storing a plurality of personal records pertaining to the associated person, the personal records including at least:
personal information pertaining to the associated person,
current personal information,
personal history information, and
least one encoding key for encrypting and decrypting the records,
at a record card interaction site, reading the records from the record card by means of the read card read/write device and decrypting the records by means of the at least one encoding key, and
when there is at least one record pertaining to the associated person stored at the interaction site, comparing the records read from the record card with the at least one record stored at the interaction site to determine differences between a record read from the record card and a corresponding record stored at the interaction site,
when there is at least one record read from the record card that was written into the record card at a different interaction site, determining whether a complete copy of a remotely entered record should be accessed and, if a complete copy should be accessed, accessing a complete copy of the remotely entered record through the record network,
generating at least one of a newly generated record and a modified record,
encrypting the at least one of a newly generated record and a modified record by means of the at least one encoding key, and
writing the at least one of a newly generated record and a modified record to the record card by means of the record card read/write device.

16. The record card of claim 15, wherein:
the records are medical records of the associated person, wherein
the current personal information includes current medical information, and
the personal history information includes medical history information.

17. The record card of claim 16, wherein:
the records further include medical insurance information.

18. The record card of claim 15, wherein interaction sites comprise at least one of:
a doctor's office,
a medical clinic,
a specialized medical service facility,
a mobile medical unit,
an emergency medical unit,
a hospital,
a hospital department,
a pharmacy,
a private care facility,
a home care unit,
an insurance provider,
a governmental agency, and
a government service.

19. The method of claim 15, wherein a patient interaction site comprises a general purpose device including a processor, a memory for storing a record access and display program, a unique identifier of a corresponding patient, and at least one encoding key for decrypting the records, and a display and input/output element and a network connection.
